(19) United States
(12) Patent Application Publication
(10) Pub. No.: US 2016/0247233 A1
(43) Pub. Date: Aug. 25, 2016

(54) MOBILE PAY INTERFACE WITH CUSTOMIZED FINANCIAL STATEMENTS AND TARGETED MARKETING PROMPTS

(71) Applicant: Mobile Financial Management Solutions, LLC, Cincinnati, OH (US)

(72) Inventor: Brian Page, Cincinnati, OH (US)

(21) Appl. No.: 15/046,865

(22) Filed: Feb. 18, 2016

Related U.S. Application Data
(60) Provisional application No. 62/118,605, filed on Feb. 20, 2015.

(51) Int. Cl. G06Q 40/06; G06Q 20/32; G06Q 20/40

(52) U.S. Cl. CPC G06Q 40/06; G06Q 20/405; G06Q 20/32

(57) ABSTRACT

A method and system of providing targeted marketing of financial products and/or services through a mobile pay application including collecting, during an application set-up process, user financial information including user specific financial goals, tracking the user specific financial goals during user account transactions, and using progress of the financial goals to identify user specific opportunities for financial product and service marketing.

### CROSS-REFERENCE TO RELATED APPLICATIONS

This application claims the benefit of U.S. Provisional Application No. 62/118,605, filed on Feb. 20, 2015, which is incorporated herein in its entirety by this reference.

### FIELD OF THE INVENTION

The present invention relates to mobile banking systems and, more particularly, to mobile payment methods and systems which track user progress towards financial goals in order to select and provide personalized, timely financial education information and targeted marketing of financial products and services to consumers.

### BACKGROUND OF THE INVENTION

There is an increasing trend, especially amongst younger generations, to rely on mobile applications (or mobile web-based platforms) to perform day-to-day tasks and receive information. This trend has led to a change in the way that financial institutions deliver information and provide services to their customers. Increasingly, the field of commerce is transitioning away from cash-based and tangible payment options, such as credit cards and debit cards; towards mobile pay solutions, such as Apple Pay, Starbucks® app for iPhone®, and other virtual wallet tools. Mobile pay platforms are becoming an integral part of financial institutions' service offerings. Consumers, especially younger generations, are increasingly trending towards the use of cashless solutions for payment, and the mobile pay space provides the next frontier for personalized cash management.

Additionally, consumers desire assistance in managing personal finances and reaching financial goals, including retirement funding. In addition to banking services, financial institutions typically market financial services and products, including wealth management, financial planning, car loans, mortgages, student loans, and other money management products to their customers. Existing marketing techniques are expensive and time consuming, in that the channels, such as direct mail and telemarketing, sweep in large volumes of recipients that may have little to no interest or use for the product or service being offered.

Accordingly, it is desirable to have a method of identifying, within a group of consumers, those individuals most likely to have an interest in a particular product or service. Further, it is desirable to have a method of exploiting mobile application platforms in the identification of individuals most likely to have an interest in a particular financial product or service. In addition, it is desirable to have systems and methods for collecting data analytics related to consumers' financial goals, and to deliver simplified financial education information and product promotions related to the consumers' goals. Further, it is desirable to have systems and methods for providing simplified, real-time displays of financial information, impulse alternatives to spending, and financial education information while making payment decisions, and to have the convenience of these systems and methods on a mobile device.

### SUMMARY OF THE INVENTION

Accordingly, the mobile pay application described herein provides a user with customized, in-time financial education information while making payment decisions. Additionally, the application provides simplified displays of consumer financial goals and balances, and impulse alternatives to spending, through a mobile application interface. The systems and methods described herein also allow financial institutions the opportunity to collect financial data on consumers to provide opportunities for targeted sales and financial support service offerings.

Through a mobile device application, the in-time, customized financial education messages can be personalized to the individual user, based on a variety of circumstances surrounding the institution's financial products, as well as the user's specific financial goals. The user specific financial goals, coupled with established and ongoing consumer financial goals, enable the financial institution to provide targeted marketing of products related to the user's goals to increase the success rate of financial institution product service calls.

In a first aspect, a method of providing targeted marketing of financial products and/or services through a mobile pay application is provided including collecting, during an application set-up process, user financial information including user specific financial goals, tracking the user specific financial goals during user account transactions, and using progress of the financial goals to identify user specific opportunities for financial product and service sales pushes.

In a second aspect, a computer implemented method is provided for identifying opportunities for targeted financial product sales by a financial institution. The method includes providing a user interface via an application on a mobile device, collecting user financial account information including one or more user specific financial goals through the user interface, and tracking the user specific financial goals during user account transactions. Progress of the user specific financial goals can be used to provide opportunities for financial product and/or service marketing to the user.

In a third aspect, a computer system for identifying opportunities for targeted financial product and/or service sales by a financial institution is provided which includes a processor and one or more memory devices communicatively coupled with the processor. The one or more memory devices storing instructions to provide a user interface via an application on a mobile device, the user interface rendering information related to user specified financial goals and linked user financial accounts, to track the user specified financial goal during account transactions, and to provide targeted marketing of financial institution products and/or services based upon progress of the user specified financial goals.

The objects and advantages of the present invention shall be made further apparent from the accompanying drawings and the description thereof.

### BRIEF DESCRIPTION OF THE DRAWINGS

FIG. 1 is a block diagram illustrating a mobile device including a mobile payment app according to an exemplary embodiment;

FIG. 2 is a flowchart diagram illustrating an exemplary set-up process for the mobile payment app;

FIG. 3 is an exemplary customized financial interface and display for the mobile payment application;

FIG. 4 is a flowchart depicting an impulse save function;

FIG. 5 is a flowchart depicting a financial goal setting and tracking process; and

FIG. 6 is a flowchart depicting a retirement goal setting process.

### DETAILED DESCRIPTION OF THE INVENTION

Usage of digital information on the go has surged in recent years due to advancements in technology. An end user may consume such information using a portable electronic device. Portable electronic devices, herein referred to as mobile devices, may include a handheld computing device, enterprise digital assistant (EDA), a wearable computer, personal digital assistant (PDA), tablet computer, smartphone, internet appliance, multifunction electronic device, or other portable device having processing capabilities. The mobile devices may include mobile hardware (e.g., memory, processor, motherboard, graphic cards, etc.), mobile software (e.g., operating system, applications, etc.), and an input mechanism (e.g. touch screen interface, keypad, etc.) to enable user interaction with the mobile device. The mobile devices may exchange data or information with remotely located servers using available network or Internet services. End users may utilize data on the mobile devices using mobile applications.

Mobile applications are software applications that may be installed on or integrated in an operating system of a mobile device. Mobile applications, either standalone or integrated, herein referred to as “app” or “apps” may be developed and distributed through private or public distribution platforms that may typically be owned by mobile operation system providers or corporate enterprises. The apps may enhance the mobility experience of the end users by providing user interfaces to access and consume digital information. The apps may be configured to provide operational features, such as, generating visualizations by analyzing and processing data, and providing user interfaces (UIs) for executing specific tasks and functionalities. The apps may consume personal data or business data, such as, contacts, e-mails, calendar, etc., available on the mobile devices for managing and executing such tasks and functionalities. The various embodiments of the systems and methods described herein are implemented via computer software or executable instructions or code, which can be stored in any appropriate type of computer readable medium for access and execution by a processor for performing the steps described herein.

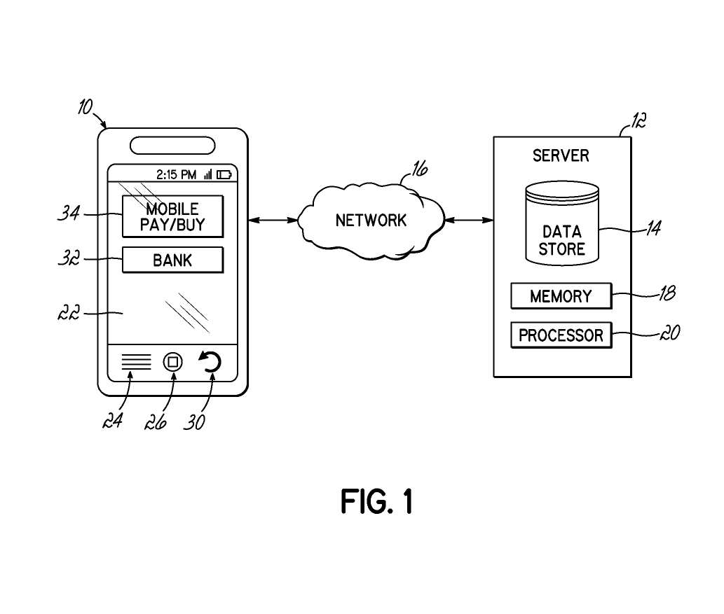

Referring now to the drawing figures, in which like numbers indicate like elements throughout the views, FIG. 1 is a block diagram of a mobile device 10 including multiple apps, according to an exemplary embodiment. As shown in FIG. 1, mobile device 10 communicates with a server 12 and a data store 14 associated with a financial institution over a network 16. Server 12 may include a memory 18 for storing computer software and executable instructions and code for access and execution by a processor 20 for interfacing with an application as described herein. Data store 14 may be associated with a particular financial institution, and store personal data and business data related to user financial accounts, including financial goals, payment histories, and other financial information. Data store 14 may include a database, an in-memory database, an operational data store, a web-based data service, or a database deployed in a cloud computing environment, containing structured and unstructured data. The business data or personal data may be stored in multiple data structures, for example, tables, tree structures, or graphs, in the data store 14.

Mobile device 10 includes a touch screen interface 22 to display information and enable user interaction including input of data. The mobile device may include buttons, such as, for example, menu button 24, home button 26, and back button 30. Mobile device 10 also includes a processor and associated memory for executing program instructions or code for performing the method steps described herein. A user enters an application as described herein by selecting a mobile interface icon associated with a proffering financial institution's mobile banking application, or through an online interface. Upon accessing the financial institution's mobile banking application, interface 22 of the mobile device 10 may display options such as a “BANK” application 32, and a “MOBILE PAY/BUY” application 34, as shown in FIG. 1. For purposes of this disclosure, these options will be designated as “BANK” 32 and “MOBILE PAY/BUY” 34, however other labels or terminology may be used to refer to the applications described herein. As used herein, the term financial institution can include any type of business providing monetary services to consumers including, among others, a bank, savings and loans, credit union, credit card companies, insurance companies, consumer finance companies, stock brokerages and investment funds. A user may access the application interface, shown in FIG. 1, by installing a previously established mobile banking platform offered by the financial institution on mobile device 10, or by using an on-line web-based interface. The mobile banking platform may be offered by a financial institution to customers as part of its financial services offerings. The mobile pay/buy application described herein can be offered by a financial institution as an additional service offering to customers for enhancing the mobile banking experience. Upon selecting the “BANK” option 32, shown in FIG. 1, a user may be directed into the financial institution's current mobile banking application to conduct routine banking functions such as bill pay or check deposit.

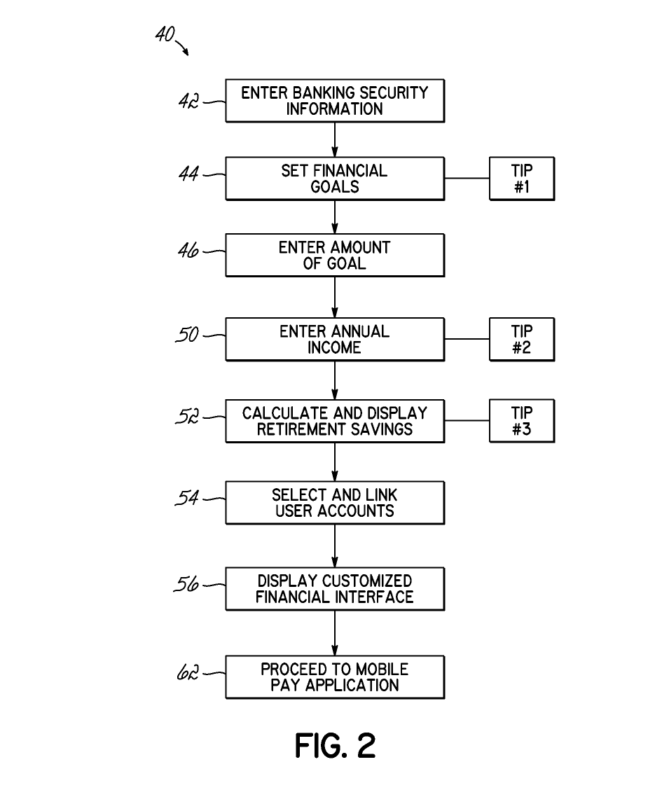

When a user initially selects the mobile pay/buy application 34 through the interface 22, the user is directed into a registration process, illustrated in FIG. 2, through which the user can establish a profile for linking with products and services offered by the financial institution. This mobile pay set-up process 40 is typically the default process during a user's first entrance into the mobile pay/buy application 34. Upon entering the mobile pay set-up process 40, the user may be prompted for different types of financial information related to financial goals, retirement planning, and information regarding accounts with the financial institution, in order to establish a profile for the mobile pay/buy application 34.

In particular, in an initial step 42, as shown in the flowchart of FIG. 2, the user may be prompted to enter the user's previously established mobile banking security information. This security information may include a user identification code and/or password previously established by the user with the financial institution. Entry of the security information enables the user's banking information, including financial account information, to be populated in the setup process. Following establishment of the user's banking identity, the user may be prompted to set one or more financial goals, including but not limited to: savings goals, debt reduction goals and/or major purchase goals (44). The user may input a goal by typing the goal in a pop-up screen on interface 22, or by selecting from a list of goal options presented on a display screen. When a goal is entered or selected, a form may be presented, such as through a drop down box on interface 22, to allow the user to input a monetary amount for the goal (46). Following input of a monetary amount for the goal, the user may be presented with one or more savings and/or debt reduction options. These options may be based off a partial or complete list of current (or future) financial products offered by the institution, and may be presented to the user through pop-up questions on interface 22 such as, “What are you saving for?” or “What debts are you reducing?” Options for user savings goals that may be presented to the user through a pop-up list include, but are not limited to: purchasing a home, purchasing an automobile, purchasing a boat, purchasing an RV, emergencies, small business venture and college. The user has the opportunity to select what they may be saving for and/or what the specifics of their financial goals may be. The user may enter a single goal, or alternatively, be continually prompted in order to enter numerous financial goals. Data related to the entered user specific goals is cached on data store 14, or another form of data retention utilized by the financial institution. After an initial establishment of goals, mobile pay/buy app 34 may query the user periodically (such as, for example, every 3 months) as to whether the user would like to modify the selected financial goals.

In addition to financial goals, the mobile pay set-up process 40 may prompt a user for additional information including, for example, annual income, as indicated at block 50. The user's response to the annual income question may be employed by the financial institution to calculate a recommended amount of money, based on the user's income level, needed to retire. The recommended amount of money to retire may be based on industry and/or financial institution estimates, and may use an 11× multiple for current income, which may be based off of industry and/or financial institution estimates. The results of this calculation may be displayed on the mobile device interface 22, as indicated at 52. Based on the calculated retirement amount estimate, the mobile pay set-up process 40 may prompt the user for information regarding retirement planning, including possible questions such as, “Are you confident in your current retirement plan?” These questions may be presented through a drop down box enabling the user to indicate “Yes” or “No” responses. Messages may be prompted and displayed on mobile device interface 22 based on the user's responses to these questions. These messages may include “Congratulations!” for a “Yes” response, or “Consider meeting with a financial planning expert to learn how to invest enough for retirement”, for a “No” response. Additionally, for users entering “No” responses, their responses and corresponding data, including annual income and estimated retirement savings, may be stored by the financial institution for use in targeting the sale of products to the user. An alert may be delivered to wealth managers or other representatives with the financial institution to empower them to contact the user. In addition to the query prompts, one or more financial tips may be presented to the user on the display interface 22 during the registration process, as indicated in FIG. 2. These tips can include suggestions such as “Do you know how much you may need to have saved for retirement?”

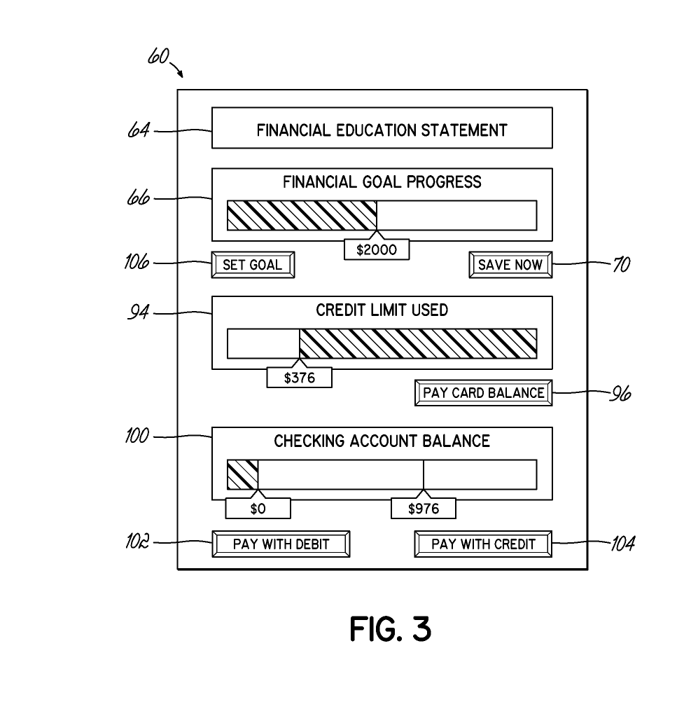

After input of user responses to the set-up application queries, user information may be pulled into the mobile pay set-up process 40 from preexisting user accounts with the financial institution's banking system, or through other means. This information may include information related to user checking, savings, credit, debit, etc. accounts, as well as existing balances in the user accounts. The user account information with the financial institution automatically populates during the set up process 40, allowing the user to select one or more accounts to indicate as primary accounts (54). Following selection of one or more primary accounts, a customized financial interface is calculated for the user and displayed by the application (56). This customized financial interface may include one or more personalized financial education statements, financial goal progress visuals, an option for setting a financial goal, an impulse save button, credit card utilization visuals, a credit card payment button, checking account balances visual (that may include a minimum balance requirement), a button to buy with credit, and a button to buy with debit among other options. FIG. 3 illustrates an exemplary screen of a mobile device 10 showing a customized financial user interface 60 rendered by mobile pay/buy application 34. The exemplary customized financial interface 60 may be displayed on mobile device 10 at the conclusion of the mobile pay set-up process 40, and is an initial screen display upon entering the mobile pay/buy application 34. After completing the mobile pay set-up process 40, the user continues into the mobile pay/buy application 34, as indicated at 62 in FIG. 2. Following use of the mobile pay set-up process 40, the user may receive a follow-up registration email that contains additional information regarding, but not limited to, financial education, financial tools and the Mobile Banking applications resources. User input in the set-up process may be utilized in preparing financial education tips.

The user specific financial goal data collected during the mobile pay set-up process 40 is compiled and stored by the financial institution. Following the set-up process, the financial institution continues to track financial transactions made by the user through normal banking channels, including the mobile banking app, financial institution website, retail banking centers, or through other means. When one of the specified user goals is met, an alert may be sent within the financial institution to the designated area or department related to the specific financial goal selected. For example, attainment of the goal “down payment for a house” may trigger an alert to a loan origination team, thereby enabling the team to reach out to the user with specific product offerings, including mortgage loans and other debt products available from the financial institution. Similarly, user input received in the mobile pay set-up process 40 regarding income and retirement planning may be stored by the financial institution for subsequent targeted marketing opportunities. From input of the user retirement data, or subsequent thereto, alerts may be triggered within the financial institution for product teams responsible for wealth management/financial planning to reach out to or target the user regarding financial products and/or services related to retirement planning. In addition to alerts, a financial institution may reach out at any time to a consumer to market products or services using financial information obtained through the mobile application.

Following completion of the setup process 40, the user may access the mobile pay/buy application 34 directly by selecting the app on interface 22, as indicated by the mobile pay/buy button 34 shown in FIG. 1. As described above, a user may enter the mobile pay/buy application 34 through the financial institution's mobile pay platform in order to make a purchase, conduct a transaction, or to view a balance. User preferences for account balances and credit utilization rates may be loaded into the mobile pay/buy application 34 from existing user account data with the financial institution, in addition to the user's current balances. A user may view their current account balances via the customized financial interface 60, which may be shaded to be a variety of colors based on user preferences, to inform the user of their current financial standing, and progress towards their selected financial goals.

Upon entering the mobile pay/buy application 34, interface display 60 may depict one or more personalized financial education tips or statements in a screen area 64. These statements may be related to a user's current financial standing, their specified financial goals, and/or other data related to the user. These statements are referred to herein as “in time” statements, as the statements are displayed to the user at the time of a purchase or other user action through the interface display 60. The statements may reflect the preferences established by the user through the mobile pay set-up process 40, including, but not limited to, credit utilization, savings account balances, and checking account balances. The statements may also reflect preferences set by the financial institution. Triggers for the particular statements are set by the financial institution and may be rotating in nature. The designated trigger labels may also be assigned by the financial institution. The financial education statements are designed to encourage a user towards healthy financial behaviors including impulse savings, debt repayment, and others; as well as assisting the user in thinking about purchases and their future implications at the time of a purchasing decision. Following display of a financial tip or statement in display screen 64, the user may dismiss the statement and proceed with the mobile pay application, or exit the application. Exemplary financial education statements that may be utilized within mobile pay/buy application 34, and associated triggers for the statements, include:

RED=Account could be incurring fees or damaging the user's credit.

YELLOW=Account balance could be close to incurring fees or close to damaging the user's credit.

GREEN=Account balance likely not in danger of incurring fees or likely not damaging the user's credit.

Exemplary Statements for Accounts WITHOUT a credit card

| Checking | Savings | Statement |
|---|---|---|
| Red | Green | Consider unnecessary checking account fees, |
| | | spending priorities and savings goals. |
| Red | Yellow | Consider unnecessary checking account fees, |
| | | spending priorities and savings goals. |
| Red | Red | Consider spending priorities when checking and |
| | | savings account balances are low. |
| Yellow | Green | Consider future unpaid bills. |
| Yellow | Yellow | Consider future unpaid bills and savings goals. |
| Yellow | Red | Consider future unpaid bills and savings account |
| | | fees. |
| Green | Green | Consider discussing with an expert strategies to |
| | | take action after reaching your savings goals. |
| Green | Yellow | Consider any unpaid future bills and saving more |
| | | now to reach your savings goals. |
| Green | Red | Consider the future benefits of reaching your |
| | | savings goals and unnecessary savings account fees. |

Exemplary Statements for Accounts WITH a credit card

| Checking | Savings | Credit | Statement |
|---|---|---|---|
| Red | Red | Red | Consider spending priorities |
| | | | and the consequences |
| | | | associated with account limits |
| | | | and requirements. |
| Red | Red | Yellow | Consider spending priorities |
| | | | and the consequences |
| | | | associated with account limits |
| | | | and requirements. |
| Red | Red | Green | Consider spending priorities |
| | | | and strategies to avoid |
| | | | incurring unnecessary fees. |
| Red | Yellow | Red | Consider spending priorities |
| | | | and consequences associated |
| | | | with account limits and |
| | | | requirements. |
| Red | Yellow | Yellow | Consider spending priorities |
| | | | and consequences associated |
| | | | with account limits and |
| | | | requirements. |
| Red | Yellow | Green | Consider spending priorities |
| | | | and strategies to avoid |
| | | | incurring unnecessary fees. |
| Red | Green | Red | Consider account balances and |
| | | | spending priorities. |
| Red | Green | Yellow | Consider spending priorities |
| | | | and account requirements. |
| Red | Green | Green | Consider fees associated with |
| | | | account requirements. |
| Yellow | Red | Red | Consider spending priorities |
| | | | and consequences associated |
| | | | with account limits and |
| | | | requirements. |
| Yellow | Red | Yellow | Consider spending priorities |
| | | | and consequences associated |
| | | | with account limits and |
| | | | requirements. |
| Yellow | Red | Green | Consider future benefits of |
| | | | reaching your savings goals |
| | | | and fees associated with |
| | | | account requirements. |
| Yellow | Yellow | Red | Consider spending priorities; |
| | | | as well as consequences |
| | | | associated with account limits |
| | | | and requirements. |
| Yellow | Yellow | Yellow | Consider future unpaid bills, |
| | | | savings goals and the |
| | | | consequences of a higher |
| | | | credit card balance. |
| Yellow | Yellow | Green | Consider future unpaid bills, |
| | | | savings goals and the benefits |
| | | | of keeping a low credit card |
| | | | balance. |
| Yellow | Green | Red | Consider spending priorities |
| | | | and account requirements. |
| Yellow | Green | Yellow | Consider future unpaid bills |
| | | | and consequences of a higher |
| | | | credit card balance. |
| Yellow | Green | Green | Consider future unpaid bills |
| | | | and the benefits of keeping a |
| | | | low credit card balance. |
| Green | Red | Red | Consider your savings goals |
| | | | and the consequences |
| | | | associated with account limits |
| | | | and requirements. |
| Green | Red | Yellow | Consider your savings goals |
| | | | and the consequences |
| | | | associated with account limits |
| | | | and requirements. |
| Green | Red | Green | Consider unnecessary savings |
| | | | account fees and savings goals. |
| Green | Yellow | Red | Consider future unpaid bills, |
| | | | savings goals and the |
| | | | consequences of a high credit |
| | | | card balance. |
| Green | Yellow | Yellow | Consider future unpaid bills, |
| | | | savings goals and the |
| | | | consequences of a higher |
| | | | credit card balance. |
| Green | Yellow | Green | Consider future unpaid bills, |
| | | | savings goals and the benefits |
| | | | of maintaining a low credit |
| | | | card balance. |
| Green | Green | Red | Consider future unpaid bills |
| | | | and the benefits of reducing |
| | | | credit card debt. |
| Green | Green | Yellow | Consider future unpaid bills |
| | | | and the consequences of a |
| | | | higher credit card balance. |
| Green | Green | Green | Consider discussing with an |
| | | | expert strategies to take |
| | | | action after reaching your |
| | | | savings goals. |

The financial education statements may be stored as a table listing in the data store 14 for access in real-time when a user initiates a purchase through the mobile pay/buy app 34. In addition to these statements, periodically, such as every 3 months, the user may be prompted with a financial statement asking if the user would like to modify their financial goals.

The customized financial interface, as depicted in FIG. 3, may also include a visual depicting the user's financial goal progress, as indicated at 66. The financial goal, which may be a savings or debt reduction goal, may be established by the user during the registration process in the mobile pay set-up application 40. A single goal may be visualized on interface 60, as shown in FIG. 3. Alternatively, interface 60 may be modified in order to visualize multiple goals. The visual is populated based on the user's specified goal(s) and other information, and the linked account minimum balance requirements. When a particular goal has been reached with the linked account balance, the pay/buy application 34 may trigger the user to establish a new financial goal. Prior to making a purchase, the user may also be prompted to establish a financial goal. When the user commits to establishing a new financial goal, the goal setting procedure, described above with respect to the mobile pay set-up process 40, is re-initiated.

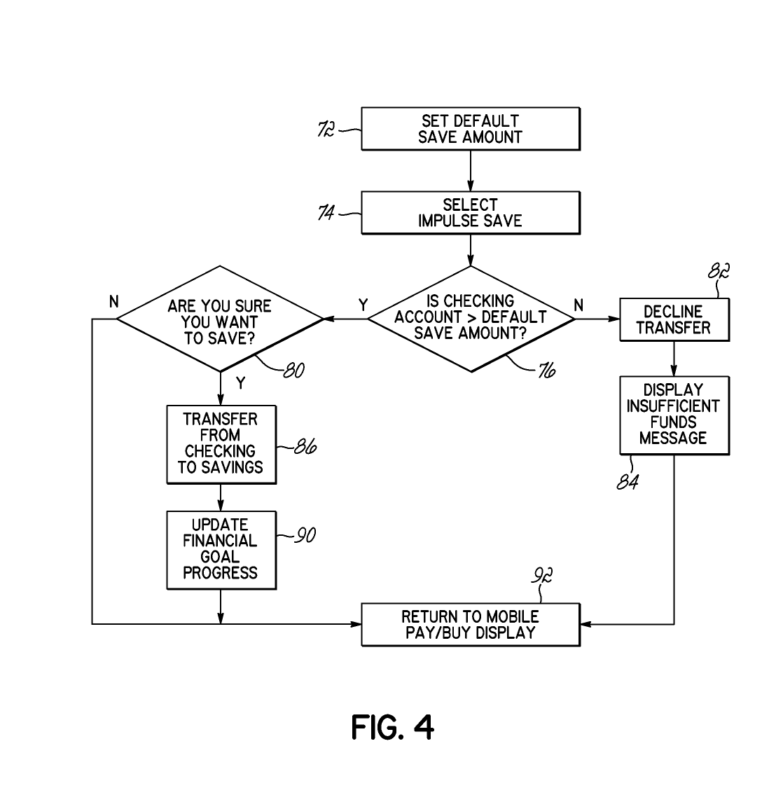

Through financial interface 60, a user may also have the option to impulsively save instead of making a purchase. This option may be presented to the user through an indicator such as, for example, the “Save Now” button 70 shown in FIG. 3. The impulse “Save Now” button 70 links the user's selected checking account to a user's selected savings account. The user may select the “Save Now” button 70 as an alternative to a purchase. The impulse save option is shown in greater detail in FIG. 4. As shown in FIG. 4, a default save amount may be established by the financial institution and/or the individual user (72). When the user selects the “Save Now” button 70, as indicated at 74, if there is an adequate balance in the user's checking account, (76) the user may be prompted with a statement related to the transaction such as, for example, “Are you sure you want to save by transferring $25 from checking to saving?”(80). If there is an insufficient balance in the user's checking account, the transfer will be declined (82), and the user may be notified of such with a message such as, for example, “Insufficient Funds” (84). If the transfer is approved, the default amount is transferred from the user's linked checking account to the user's linked savings account (86). The transfer may immediately impact the “Financial Goal Progress” visual 66 on interface 60, as indicated at 90. After selecting the impulse save feature, the user may return to the financial interface display 60, as indicated at 92.

Customized financial interface 60 also provides a “Credit Limit Used” visual, as indicated at 94, depicting the credit card utilization rate of the user's linked credit card. The “Credit Limit Used” visual 94 may be populated based on the user's linked account credit limit and current account information. The visual 94 provides an in time cue for the user to resist borrowing using the credit card based on the financial institution's cued credit card utilization rates, user preferences, or generally accepted guidance. Utilization rates may be set by the financial institution, the user, or based on generally accepted standards.

Customized financial interface 60 may also include a selection to allow the user to pay down a debt in place of making a purchase, or on an impulse. This option may be presented to the user through an indicator such as, for example, the “Pay Card Balance” button 96. The impulse pay function may link one or more of the user's savings or checking accounts to the user's linked credit card. The user may select the “Pay Card Balance” button 96 as an alternative to a purchase. When button 96 is selected, the user is prompted with a screen on interface 22, allowing the user to input an amount to transfer from a linked checking or savings account to pay down or pay off the card balance, as well as to select the account to pay from, if the user has more than one linked account. The “Pay Card Balance” button 96 may also be linked to other debts external to the financial institution. If there are sufficient funds in the user's linked and selected account, the user may be prompted with a confirming statement for the transaction such as, for example, “Are you sure you want to make the ($amount) payment towards your credit card balance?” If there are insufficient funds in the user's linked and selected account, the transfer may be declined, and the user may receive a prompt such as “Insufficient Funds”. If the transfer is approved, the transfer may immediately impact the “Credit Limit Used” visual 94. After selection of the “Pay Card Balance” button 96, the user may remain at the mobile pay/buy application interface 60.

Interface 60 may also include a “Checking Account Balance” visual, as shown at 100. Checking Account Balance visual 100 enables a user to view their balance for one or more linked checking accounts, as well as areas where fees may be imposed. Checking Account Balance visual 100 may be populated based on the linked account minimum balance requirement and current account information. Visual 100 may cue the user to resist using the linked checking account for purchases when approaching minimum balance requirements. When the user selects the checking account to make a purchase, the checking account balance visual 100 may be immediately updated to reflect the purchase.

To facilitate purchases, customized financial interface 60 also provides the user with an option of entering into the financial institution's mobile pay interface. Selecting this option allows the user to make a purchase using some financial product, including their debit and/or credit accounts. If the user selects the “Pay with Debit” button 102, the user may be triggered into a mobile pay screen linked to the checking account or debit card information. Once the purchase is made, the mobile pay/buy application 34 may be closed, or the application may be redirected back to customized financial interface 60. If the user selects the “Pay with Credit” button 104, the user may be triggered into the mobile pay screen linked to the financial institution credit card account. Once the purchase is made, the mobile pay/buy application 34 may be closed, or the application may be redirected back to customized financial interface 60.

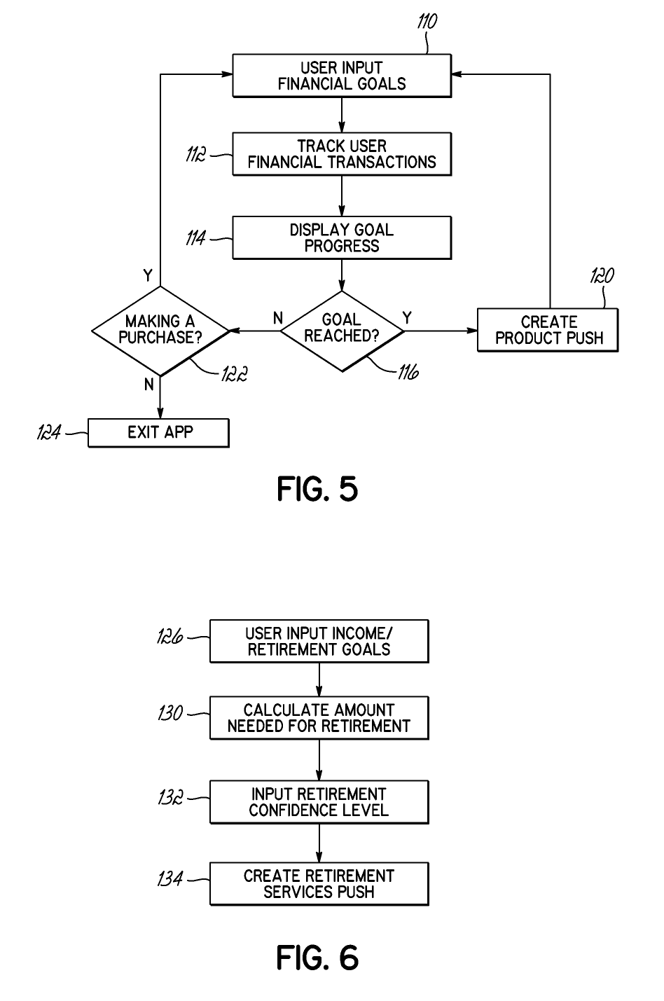

FIGS. 5 and 6 illustrate the goal setting and tracking processes of the mobile pay/buy application 34 in greater detail. In addition, the figures illustrate how a financial institution may utilize user-specified financial and retirement goals, along with other user data, to identify targeted outreach opportunities for financial institution products and/or services. As shown in FIG. 5, user specified goals may be established during the mobile pay set-up process 40 (illustrated in FIG. 2), following a purchase transaction, or upon attainment of a previous financial goal (110). The user may also opt to create a new goal by selecting the set goal option 106 on interface display 60. The set goal option may lead the user through a goal setting process similar to that described above for the application set-up process 40. The user selected financial goals may be tied to products offered by the financial institution. In addition, information regarding user spending and/or savings transactions with linked accounts is tracked and stored by the financial institution (112). The financial goal progress is displayed on interface 60, as described above, and as indicated at 114. When a user completes a financial goal per the financial institution tracking system (116), the financial institution may create an alert to reach out to that individual user with product and/or services offered by the financial institution, as indicated at 120. These product/service offerings may be tied to the user's selected financial goal(s). The financial institution may also reach out at other times, without an alert, to the user using financial information obtained and tracked through the application. In addition, upon completing a goal, the user may default into a setup process, as described above, to establish a new financial goal. If a goal is not reached, the user may proceed with making a purchase through the application 34, as indicated at 122, or may exit the app, as indicated at 124.

Similarly, as illustrated in FIG. 6, a user may have entered annual income during the mobile pay set-up process 40, as indicated at 126, and the entered income amount applied to an interactive calculator to provide an estimate or calculation (using industry and/or financial institution standards) for the amount of money that may be needed to retire. (130) The mobile pay/buy application 34 may create an educational recommendation statement for the user regarding the retirement calculation, including education recommendations such as, for example, “some wealth planners recommend a retirement savings minimum of 11 times your income.” During the mobile pay set-up process 40, the user may also have input a confidence level in their retirement planning, as indicated at 132. The retirement goal information obtained during the set-up process 40 may be compiled and utilized to create opportunities for the financial institution to direct targeted marketing pushes to the user to encourage usage of a variety of financial products, such as wealth management products, as indicated at 134.

The present invention has been described in connection with several embodiments and some of those embodiments have been elaborated in substantial detail. However, the scope of the invention is not to be limited by these embodiments which are presented as exemplary and not exclusive. The scope of the invention being claimed is set forth by the following claims.

1. A method of providing targeted marketing of financial products and/or services through a mobile pay application, the method comprising:
collecting user financial information including user specific financial goals;
tracking the user specific financial goals during user account transactions; and
using progress of the financial goals to identify user specific opportunities for financial product marketing.

2. The method of claim 1, wherein the user financial information is collected during an application set-up process.

3. The method of claim 1, wherein the mobile pay application creates a marketing opportunity alert to a financial institution based on progress of the user specific financial goals.

4. The method of claim 3, wherein an alert is triggered based on the attainment of a user specific financial goal.

5. The method of claim 1, further comprising the steps of:
using the user specific goals and user financial account information to select customized financial education statements; and
communicating the customized financial education statements through a mobile application interface.

6. The method of claim 5, wherein the customized financial education statements are communicated in a mobile payment interface at the time of a purchasing decision.

7. The method of claim 1, further comprising the step of allowing, through the mobile pay application, an opportunity to impulse save at the time of purchase.

8. The method of claim 1, further comprising the step of allowing, through the mobile pay application, an opportunity to impulse pay down debt at the time of purchase.

9. The method of claim 6, wherein the financial education statements are further selected based upon user preferences for account balances.

10. The method of claim 6, wherein the financial education statements are further selected based upon user preferences for credit utilization.

11. The method of claim 1, wherein the step of collecting user financial information further comprises receiving user annual income information; and wherein the annual income information is used to identify user specific targeted marketing opportunities.

12. The method of claim 11, wherein the step of collecting user information further comprises receiving user retirement goal information, and wherein the retirement goal information is used to identify user specific marketing opportunities.

13. A computer implemented method for identifying opportunities for targeted financial product sales by a financial institution, the method comprising:
providing a user interface via an application on a mobile device;
collecting user financial account information including one or more user specific financial goals through the user interface;
tracking the user specific financial goals during user account transactions; and
using progress of the user specific financial goals to create an opportunity for financial product and/or service marketing to the user.

14. The computer implemented method of claim 13, wherein the user financial information is collected during an application set-up process.

15. The computer implemented method of claim 13, further comprising:
identifying from the one or more user selected financial goals and user financial position one or more financial education statements; and
communicating the one or more financial education statements through the user interface.

16. The computer implemented method of claim 15, wherein the financial education statement is identified based upon prior payment decisions by the user.

17. The computer implemented method of claim 15, wherein the financial education statement is communicated at the time of a purchasing decision.

18. The computer implemented method of claim 13, wherein the step of collecting user financial information further comprises receiving user annual income and retirement goal information; and wherein the annual income and retirement goal information are used to identify opportunities for financial product and/or service marketing to the user.

19. A computer system for identifying opportunities for targeted financial product and/or service sales by a financial institution, comprising:
a processor; and
one or more memory devices communicatively coupled with the processor and the one or more memory devices storing instructions to:
provide a user interface via an application on a mobile device, the user interface rendering information related to user specified financial goals and linked user financial accounts;
tracking the user specified financial goals during account transactions; and
providing targeted marketing of financial institution products and/or services based upon progress of the user specified financial goals.

20. The computer system of claim 19, further including instructions for collecting user annual income and retirement goal information; and for using the annual income and retirement goal information to identify opportunities for financial product and/or service marketing to the user.
